(19) United States
(12) Patent Application Publication
(10) Pub. No.: US 2019/0339755 A1
(43) Pub. Date: Nov. 7, 2019

(54) STORAGE DEVICE AND METHOD OF OPERATING THE STORAGE DEVICE

(71) Applicant: SK hynix Inc., Icheon-si Gyeonggi-do (KR)

(72) Inventor: Seung Wan CHAI, Seoul (KR)

(73) Assignee: SK hynix Inc., Icheon-si Gyeonggi-do (KR)

(21) Appl. No.: 16/218,249

(22) Filed: Dec. 12, 2018

(30) Foreign Application Priority Data
May 3, 2018 (KR) 10-2018-0051423

(51) Int. Cl. G06F 1/20; G06F 1/3296; G06F 1/3225; G06F 1/3234; G06F 3/06

(52) U.S. Cl. CPC G06F 1/206; G06F 1/3296; G06F 1/3225; G06F 1/3275; G06F 11/3058; G06F 3/0653; G06F 3/0634; G06F 3/0679; G06F 3/0616

(57) ABSTRACT

Provided herein is a storage device capable of throttling the performance of the storage device depending on the temperature. The storage device including a plurality of memory devices divided into a plurality of performance throttle groups, and a memory controller configured to obtain temperature information from indicator chips included in the plurality of respective performance throttle groups, and control operations of memory devices included in a performance throttle group selected from among the plurality of performance throttle groups based on the temperature information.

### CROSS-REFERENCE TO RELATED APPLICATION

The present application claims priority under 35 U.S.C. § 119(a) to Korean patent application number 10-2018-0051423 filed on May 3, 2018, in the Korean Intellectual Property Office, the entire disclosure of which is incorporated herein by reference.

### BACKGROUND

### 1. Technical Field

Various embodiments of the present disclosure generally relate to an electronic device, and more particularly, to a storage device and a method of operating the storage device.

### 2. Related Art

Generally, a storage device is a device which stores data under control of a host device such as a computer, a smartphone, or a smartpad. According to the type of device provided to store data, examples of the storage device may be classified into a device such as a hard disk drive (HDD) which stores data in a magnetic disk, and a device such as a solid state drive (SSD) or a memory card which stores data in a semiconductor memory, particularly, a nonvolatile memory.

The storage device may include a memory device in which data is stored, and a memory controller configured to store data in the memory device. The memory device may be classified into a volatile memory and a nonvolatile memory. Representative examples of the nonvolatile memory include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc.

### SUMMARY

An embodiment of the present disclosure may provide for a storage device including: a plurality of memory devices divided into a plurality of performance throttle groups; and a memory controller configured to obtain temperature information from indicator chips included in the plurality of respective performance throttle groups, and control operations of memory devices included in a performance throttle group selected from among the plurality of performance throttle groups based on the temperature information.

An embodiment of the present disclosure may provide for a method of operating a storage device including a plurality of memory devices divided into a plurality of performance throttle groups, and a memory controller configured to control the plurality of memory devices. The method comprising: obtaining temperature information from indicator chips included in the plurality of respective performance throttle groups; and controlling operations of memory devices included in a performance throttle group selected from among the plurality of performance throttle groups based on the temperature information.

An embodiment of the present disclosure may provide for a storage device including: a plurality of memory devices; and a memory controller configured to receive temperature information from the plurality of memory devices, and perform a performance throttling operation on at least one memory device having a temperature exceeding a threshold temperature among the plurality of memory devices, based on the temperature information.

An embodiment of the present disclosure may provide for a memory device including: a memory cell array; a temperature sensor configured to measure a temperature related to the memory cell array, and generate a temperature signal having a voltage level varying depending on the measured temperature; and a control logic configured to provide temperature information generated based on the temperature signal, to a memory controller external to the memory device in response to a request of the memory controller.

### BRIEF DESCRIPTION OF THE DRAWINGS

FIG. 1 is a block diagram illustrating a storage device in accordance with an embodiment of the present disclosure.

FIG. 2 is a diagram illustrating the configuration of a memory device of FIG. 1.

FIG. 3 is a diagram illustrating an embodiment of a memory cell array of FIG. 2.

FIG. 4 is a circuit diagram illustrating any one memory block BLKa of memory blocks BLK1 to BLKz of FIG. 3, in accordance with an embodiment of the present disclosure.

FIG. 5 is a circuit diagram illustrating any one memory block BLKb of the memory blocks BLK1 to BLKz of FIG. 3, in accordance with an embodiment of the present disclosure.

FIG. 6 is a block diagram illustrating an embodiment of connection relationship between a memory controller and a plurality of memory devices of FIG. 1.

FIG. 7 is a diagram for describing the operation of a performance adjustment unit of FIG. 1.

FIG. 8 is a diagram for describing an operation of throttling the performance depending on the temperature in a storage device.

FIG. 9 is a diagram for describing a performance throttling operation in accordance with an embodiment of the present disclosure.

FIG. 10 is a diagram for describing a performance throttling operation in accordance with an embodiment of the present disclosure.

FIG. 11 is a flowchart for explaining an operation of the storage device in accordance with an embodiment of the present disclosure.

FIG. 12 is a flowchart for explaining an operation of the storage device in accordance with an embodiment of the present disclosure.

FIG. 13 is a diagram illustrating an example of the memory controller of FIG. 1 in accordance with an embodiment of the present disclosure.

FIG. 14 is a block diagram illustrating a memory card system to which a storage device in accordance with an embodiment of the present disclosure is applied.

FIG. 15 is a block diagram illustrating a solid state drive (SSD) system to which the storage device in accordance with an embodiment of the present disclosure is applied.

FIG. 16 is a block diagram illustrating a user system to which the storage device in accordance with an embodiment of the present disclosure is applied.

### DETAILED DESCRIPTION

Examples of embodiments will now be described hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the examples of embodiments to those skilled in the art.

In the drawing figures, dimensions may be exaggerated for clarity of illustration. It will be understood that when an element is referred to as being “between” two elements, it can be the only element between the two elements, or one or more intervening elements may also be present.

Hereinafter, embodiments will be described with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as “first” and “second” may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, “and/or” may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

Various embodiments of the present disclosure may be directed to a storage device configured to perform a cache read operation by each memory device, and a method of operating the storage device.

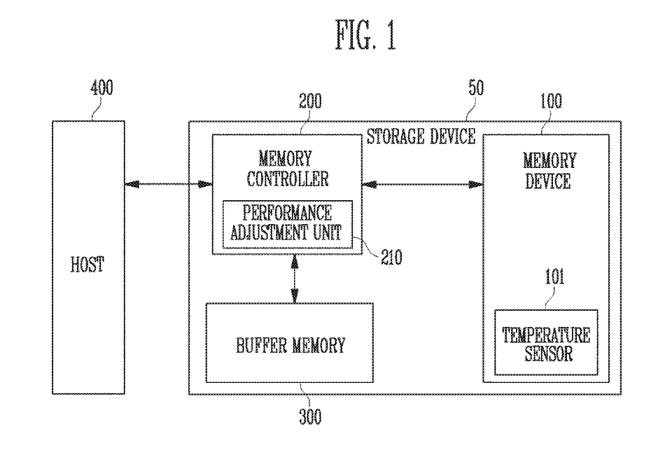

FIG. 1 is a block diagram illustrating a storage device 50 in accordance with an embodiment of the present disclosure.

Referring to FIG. 1, the storage device 50 may include a memory device 100, a memory controller 200, and a buffer memory 300.

The storage device 50 may be a device configured to store data under control of a host 400 such as a cellular phone, a smartphone, an MP3 player, a laptop computer, a desktop computer, a game machine, a TV, a tablet PC, or an in-vehicle infotainment system, etc.

The storage device 50 may be configured of any one of various kinds of storage devices depending on a host interface, which is a communication system with the host 400. For example, the data storage device 50 may be configured of any one of various kinds of storage devices such as an SSD, MMC, eMMC, RS-MMC, or micro-MMC type multimedia card, an SD, mini-SD, micro-SD type secure digital card, a universal serial bus (USB) storage device, a universal flash storage (UFS) device, a personal computer memory card international association (PCMCIA) card type storage device, a peripheral component interconnection (PCI) card type storage device, a PCI-express (PCI-E) type storage device, a compact flash (CF) card, a smart media card, and a memory stick, etc.

The storage device 50 may be manufactured in the form of any one of various package types. For instance, the storage device 50 may be manufactured in the form of any one of various package types such as a package on package (POP) type, a system in package (SIP) type, a system on chip (SOC) type, a multi-chip package (MCP) type, a chip on board (COB) type, a wafer-level fabricated package (WFP) type, and a wafer-level stack package (WSP) type, etc.

The memory device 100 may store data therein. The memory device 100 may operate under control of the memory controller 200. The memory device 100 may include a memory cell array including a plurality of memory cells configured to store data therein. The memory cell array may include a plurality of memory blocks. Each memory block may include a plurality of memory cells. Each memory block may include a plurality of pages. In an embodiment, each page may be the unit of sorting data in the memory device 100 or reading stored data from the memory device 100. Each memory block may be the unit of erasing data. In an embodiment, the memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a rambus dynamic random access memory (RDRAM), a NAND flash memory, a vertical NAND flash memory, a NOR flash memory device, a resistive random access memory (RRAM), a phase-change memory (PRAM), a magnetoresistive random access memory (MRAM), a ferroelectric random access memory (FRAM), or a spin transfer torque random access memory (STT-RAM). In this specification, for the sake of explanation, it is assumed that the memory device 100 is a NAND flash memory, etc.

In an embodiment, the memory device 100 may be embodied in a three-dimensional array structure. The present disclosure may be applied not only to a flash memory in which a charge storage layer is formed of a conductive floating gate (FG), but also to a charge trap flash (CTF) memory in which a charge storage layer is formed of an insulating layer.

In an embodiment, each of the memory cells included in the memory device 100 may be formed of a single-level cell (SLC) capable of storing one data bit. Alternatively, each of the memory cells included in the memory device 100 may be formed of a multi-level cell (MLC) capable of storing two data bits, a triple-level cell (TLC) capable of storing three data bits, or a quad-level cell (QLC) capable of storing four data bits, etc.

The memory device 100 may receive a command and an address from the memory controller 200 and access a region of the memory cell array that is selected by the address. In other words, the memory device 100 may perform an operation corresponding to the command on the region selected by the address. For example, the memory device 100 may perform a write (program) operation, a read operation, and an erase operation. During a program operation, the memory device 100 may program data to a region selected by an address. During a read operation, the memory device 100 may read data from a region selected by an address. During an erase operation, the memory device 100 may erase data from a region selected by an address.

In an embodiment, the memory device 100 may include a temperature sensor 101. The temperature sensor 101 may measure the temperature of the memory device 100. The memory device 100 may provide, to the memory controller 200, temperature information which is information about the temperature of the memory device 100 measured by the temperature sensor 101 in response to a request of the memory controller 200.

The memory controller 200 may control overall operations of the storage device 50.

When power is applied to the storage device 50, the memory controller 200 may execute firmware. In the case where the memory device 100 is a flash memory device, the memory controller 200 may execute firmware such as a flash translation layer (FTL) for controlling communication between the host 400 and the memory device 100.

In an embodiment, the memory controller 200 may receive data and a logical block address from the host 400, and translate the logical block address into a physical block address PBA indicating addresses of memory cells to which data is to be stored, the memory cells being included in the memory device 100. The memory controller 200 may store, in the buffer memory 300, a logical-to-physical address mapping table indicating mapping relationship between logical block addresses LBA and physical block addresses PBA.

The memory controller 200 may control the memory device 100 to perform a program operation, a read operation, or an erase operation in response to a request from the host 400. During a program operation, the memory controller 200 may provide a program command, a PBA, and data to the memory device 100. During a read operation, the memory controller 200 may provide a read command and a PBA to the memory device 100. During an erase operation, the memory controller 200 may provide an erase command and a PBA to the memory device 100.

In an embodiment, the memory controller 200 may autonomously generate a program command, an address and data without a request from the host 400, and transmit them to the memory device 100. For example, the memory controller 200 may provide a command, an address and data to the memory device 100 to perform background operations such as a program operation for wear leveling, and a program operation for garbage collection.

In an embodiment of the present disclosure, the memory controller 200 may include a performance adjustment unit 210. The performance adjustment unit 210 may adjust the performance of the storage device 50 depending on the temperature of the memory device 100. For example, when the temperature of the memory device 100 exceeds a threshold temperature, the performance adjustment unit 210 may limit the operating performance of the storage device 50 to reduce the temperature of the memory device 100. Operations of limiting the performance of the storage device 50 depending on the temperature of the memory device 100 may refer to a performance throttling operation. In an embodiment, the performance adjustment unit 210 may be implemented with software, hardware, or any combination thereof,

In an embodiment, the memory controller 200 may control a plurality of memory devices 100. In this case, the performance throttling operation may be an operation of adjusting the number of memory devices 100 to be simultaneously accessed by the memory controller 200. For example, when the temperature of the memory device 100 is higher than the threshold temperature, the memory controller 200 may reduce the number of memory devices 100 to be simultaneously accessed.

In various embodiments, the performance throttling operation may be an operation of controlling the data input/output speed of the memory controller 200 and the memory device 100. For example, when the temperature of the memory device 100 is higher than the threshold temperature, the memory controller 200 may reduce the data input/output speed. The data input/output speed may be adjusted by controlling the number of channels for data input/output, the number of ways, or time (e.g., a tPROG or tREAD function) of a data write operation or a data read operation. Alternatively, the data input/output speed may be controlled by temporarily holding transmission of a command, an address and data for performing a data write operation or a data read operation. As a further alternative, with regard to control of the data input/output speed, a command, an address and data for performing a data write operation or a data read operation may be transmitted to the memory device 100 after a delay of a predetermined time has passed.

In various embodiments, the performance throttling operation may be an operation of setting the frequency of a timing signal or a clock signal to be inputted to the memory device 100 to a value less than a basic setting frequency. For example, when the temperature of the memory device 100 is higher than the threshold temperature, the memory controller 200 may reduce the frequency of a timing signal or a clock signal to be inputted to the memory device 100 to a value less than the basic setting frequency.

In various embodiments, the performance throttling operation may be an operation of activating the operation of a cooler included in the storage device 50. For example, when the temperature of the memory device 100 is higher than the threshold temperature, the memory controller 200 may activate the operation of the cooler.

Not only the above-described performance throttling operations but also other operations of limiting, by the memory controller 200, the operating performance to reduce the temperature of the memory device 100 may fall within the bounds of the performance throttling operation in accordance with embodiments of the present disclosure, and the performance throttling operation is not limited to the operations disclosed in this specification.

The performance adjustment unit 210 may receive, from the memory device 100, temperature information which is information about the temperature of the memory device 100 measured by the temperature sensor 101. The performance adjustment unit 210 may determine whether the temperature of the memory device 100 exceeds the threshold temperature, based on the temperature information. The performance adjustment unit 210 may determine a memory device the temperature of which exceeds the threshold temperature, to be a performance limit device, and perform the performance throttling operation on the corresponding memory device. For example, the performance adjustment unit 210 may limit, for a preset time, power to be supplied to the memory device that is the performance limit device. Here, the threshold temperature may be a threshold temperature over which results of operations performed by the memory device 100 may be unreliable.

In various embodiments, in the case where the memory controller 200 controls a plurality of memory devices, the plurality of memory devices may be divided into a plurality of performance throttle groups. For example, each performance throttle group may include at least two or more memory devices. Any one of the two or more memory devices included in each performance throttle group may be an indicator chip.

The performance adjustment unit 210 may receive temperature information from the indicator chips included in the respective performance throttle groups. The temperature of each indicator chip measured by a temperature sensor included in the corresponding indicator chip may be treated as the temperature of the performance throttle group including the corresponding indicator chip.

The performance adjustment unit 210 may determine whether an indicator chip the temperature of which exceeds the threshold temperature is present based on the temperature information received from the indicator chips. The performance adjustment unit 210 may determine a performance throttle group including an indicator chip the temperature of which exceeds the threshold temperature, to be a performance limit group, and perform a performance throttling operation on the memory devices included in the corresponding performance limit group. For example, the performance adjustment unit 210 may limit, for a preset time, power to be supplied to the memory devices included in the performance limit group.

In an embodiment, the memory controller 200 may control data exchange between the host 400 and the buffer memory 300. Alternatively, the memory controller 200 may temporarily store system data for controlling the memory device 100 to the buffer memory 300. For example, the memory controller 200 may temporarily store, to the buffer memory 300, data input from the host 400, and thereafter transmit the data temporarily stored in the buffer memory 300 to the memory device 100.

In various embodiments, the buffer memory 300 may be used as an operating memory or a cache memory of the memory controller 200. The buffer memory 300 may store codes or commands to be executed by the memory controller 200. Alternatively, the buffer memory 300 may store data to be processed by the memory controller 200.

In an embodiment, the buffer memory 300 may be embodied by an SRAM or a DRAM such as a double data rate synchronous dynamic random access memory (DDR SDRAM), a DDR4 SDRAM, a low power double data rate4 (LPDDR4) SDRAM, a graphics double data rate (GDDR) SDRAM, a low power DDR (LPDDR), or a rambus dynamic random access memory (RDRAM), etc.

In various embodiments, the storage device 50 might not include the buffer memory 300. In this case, volatile memory devices provided outside the storage 500 may perform the function of the buffer memory 300.

In an embodiment, the memory controller 200 may control at least two memory devices 100. In this case, the memory controller 200 may control the memory devices 100 in an interleaving manner to enhance the operating performance.

The host 400 may communicate with the storage device 50 using at least one of various communication methods such as universal serial bus (USB), serial AT attachment (SATA), serial attached SCSI (SAS), high speed interchip (HSIC), small computer system interface (SCSI), peripheral component interconnection (PCI), PCI express (PCIe), nonvolatile memory express (NVMe), universal flash storage (UFS), secure digital (SD), multimedia card (MMC), embedded MMC (eMMC), dual in-line memory module (DIMM), registered DIMM (RDIMM), and load reduced DIMM (LRDIMM) communication methods.

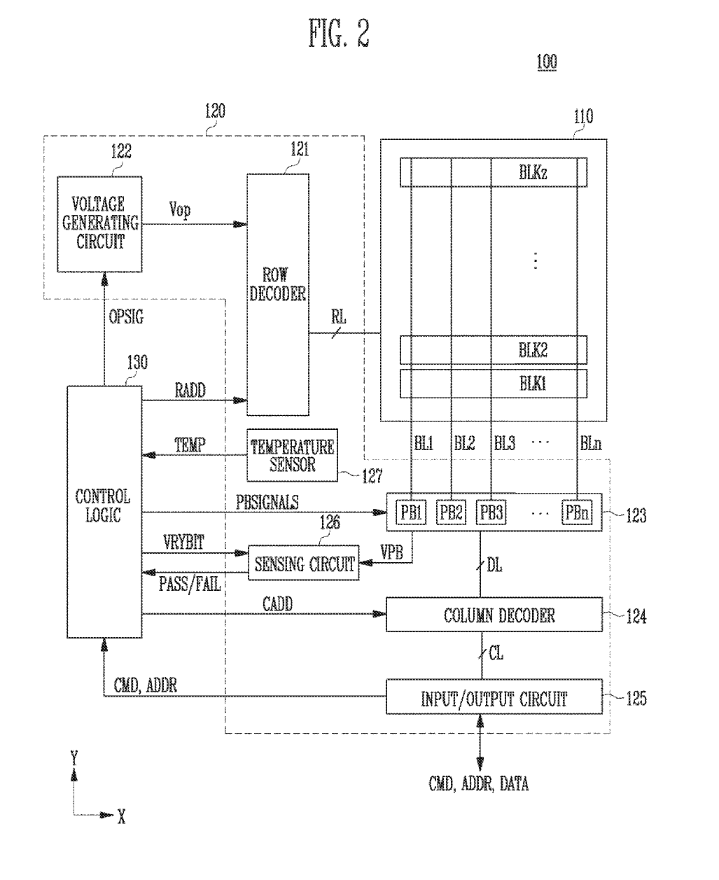

FIG. 2 is a diagram for explaining the configuration of the memory device 100.

Referring to FIG. 2, the memory device 100 may include a memory cell array 110, a peripheral circuit 120, and a control logic 130.

The memory cell array 110 may include a plurality of memory blocks BLK1 to BLKz. The plurality of memory blocks BLK1 to BLKz are coupled to a row decoder 121 through row lines RL. The plurality of memory blocks BLK1 to BLKz may be coupled to a page buffer group 123 through bit lines BL1 to BLm. Each of the memory blocks BLK1 to BLKz may include a plurality of memory cells. In an embodiment, the plurality of memory cells may be nonvolatile memory cells. Memory cells coupled to the same word line may be defined as one page. Hence, each memory block may include a plurality of pages.

The row lines RL may include at least one source select line, a plurality of word lines, and at least one drain select line.

Each of the memory cells included in the memory cell array 110 may be formed of a single level cell (SLC) capable of storing a single data bit, a multi-level cell (MLC) capable of storing two data bits, a triple-level cell (TLC) capable of storing three data bits, or a quad-level cell (QLC) capable of storing four data bits, etc.

The peripheral circuit 120 may perform a program operation, a read operation, or an erase operation on a selected region of the memory cell array 110 under control of the control logic 130. The peripheral circuit 120 may drive the memory cell array 110. For example, the peripheral circuit 120 may apply various operating voltages to the row liens RL and the bit lines BL1 to BLn or discharge the applied voltages, under control of the control logic 130. In an embodiment, the control logic 130 may be implemented with software, hardware, or any combination thereof,

The peripheral circuit 120 may include the row decoder 121, a voltage generation circuit 122, the page buffer group 123, a column decoder 124, and an input/output circuit 125.

The row decoder 121 is coupled to the memory cell array 110 through the row lines RL. The row lines RL may include at least one source select line, a plurality of word lines, and at least one drain select line. In an embodiment, the word lines may include normal word lines and dummy word lines. In an embodiment, the row lines RL may further include a pipe select line.

The row decoder 121 may operate under control of the control logic 130. The row decoder 121 may receive a row address ADDR from the control logic 130.

The row decoder 121 may decode the row address RADD. The row decoder 121 may select at least one memory block of the memory blocks BLK1 to BLKz in response to the decoded address. The row decoder 121 may select at least one word line WL of the selected memory block in response to the decoded address so that voltages generated from the voltage generation circuit 122 are applied to the at least one word line WL.

For example, during a program operation, the row decoder 121 may apply a program voltage to a selected word line and apply a program pass voltage having a level lower than that of the program voltage to unselected word lines. During a program verify operation, the row decoder 121 may apply a verify voltage to a selected word line and apply a verify pass voltage higher than the verify voltage to unselected word lines. During a read operation, the row decoder 121 may apply a read voltage to a selected word line and apply a read pass voltage higher than the read voltage to unselected word lines.

In an embodiment, an erase operation of the memory device 100 may be performed on a memory block basis. During an erase operation, the row decoder 121 may select one memory block in response to a decoded address. During the erase operation, the row decoder 121 may apply a ground voltage to word lines coupled to the selected memory block.

The voltage generation circuit 122 may operate under control of the control logic 130. The voltage generation circuit 122 may generate a plurality of voltages using an external supply voltage supplied to the memory device 100. For example, the voltage generation circuit 122 may generate various operating voltages Vop to be used for a program operation, a read operation, and an erase operation in response to an operating signal OPSIG. For example, the voltage generation circuit 122 may generate a program voltage, a verify voltage, a pass voltage, a read voltage, an erase voltage, and so forth under control of the control logic 130.

In an embodiment, the voltage generation circuit 122 may generate an internal supply voltage by regulating the external supply voltage. The internal supply voltage generated from the voltage generation circuit 122 may be used as an operating voltage of the memory device 100.

In an embodiment, the voltage generation circuit 122 may generate a plurality of voltages using an external supply voltage or an internal supply voltage.

For example, the voltage generation circuit 122 may include a plurality of pumping capacitors for receiving the internal supply voltage and generate a plurality of voltages by selectively activating the plurality of pumping capacitors under control of the control logic 130.

The generated voltages may be supplied to the memory cell array 110 by the row decoder 121.

The page buffer group 123 may include first to n-th page buffers PB1 to PBn. The first to n-th page buffers PB1 to PBn are coupled to the memory cell array 110 through the first to n-th bit lines BL1 to BLn, respectively. The first to n-th page buffers PB1 to PBn may operate under control of the control logic 130. For example, the first to n-th page buffers PB1 to PBn may operate in response to page buffer control signals PBSIGNALS. For instance, the first to n-th page buffers PB1 to PBn may temporarily store data received through the first to n-th bit lines BL1 to BLn, or sense voltages or currents of the first to n-th bit lines BL1 to BLn during a read operation or a verify operation.

For example, during a program operation, the first to n-th page buffers PB1 to PBn may transmit data DATA received through the input/output circuit 125 to selected memory cells through the first to n-th bit lines BL1 to BLn when a program pulse is applied to a selected word line. The memory cells in the selected page are programmed based on the transmitted data DATA. Memory cells coupled to a bit line to which a program allowable voltage (e.g. a ground voltage) is applied may have increased threshold voltages. Threshold voltages of memory cells coupled to a bit line to which a program inhibit voltage (for example, a supply voltage) is applied may be retained. During a program verify operation, the first to n-th page buffers PB1 to PBn may read page data from selected memory cells through the first to n-th bit lines BL1 to BLn.

During a read operation, the first to n-th page buffers PB1 to PBn may read data DATA from memory cells of a selected page through the first to n-th bit lines BL1 to BLn, and output the read data DATA to the data input/output circuit 125 under control of the column decoder 124.

During an erase operation, the first to n-th page buffers PB1 to PBn may float the first to n-th bit lines BL1 to BLn.

The column decoder 124 may transmit data between the input/output circuit 125 and the page buffer group 123 in response to a column address CADD. For example, the column decoder 124 may exchange data with the first to n-th page buffers PB1 to PBn through data lines DL or exchange data with the input/output circuit 125 through column lines CL.

The input/output circuit 125 may transmit, to the control logic 130, a command CMD or an address ADDR received from the memory controller 200 described with reference to FIG. 1, or may exchange data DATA with the column decoder 124.

During a read operation or a verify operation, the sensing circuit 126 may generate a reference current in response to an allowable bit signal VRYBIT, and may compare a sensing voltage VPB received from the page buffer group 123 with a reference voltage generated by the reference current and output a pass signal PASS or a fail signal FAIL.

A temperature sensor 127 may measure the temperature of the memory device 100. The temperature sensor 127 may provide a temperature signal TEMP having a voltage level varying depending on the measured temperature to the control logic 130. The control logic 130 may generate temperature information TEMP INFO indicating the temperature of the memory device 100 in response to the temperature signal TEMP. In an embodiment, the temperature sensor 127 is identical with the temperature sensor 101 described with reference to FIG. 1.

The control logic 130 may output an operating signal OPSIG, a row address RADD, page buffer control signals PBSIGNALS, and an allowable bit signal VRYBIT in response to a command CMD and an address ADD, and thus control the peripheral circuit 120. In addition, the control logic 130 may determine whether a target memory cell has passed or failed a verify operation in response to a pass or fail signal PASS or FAIL.

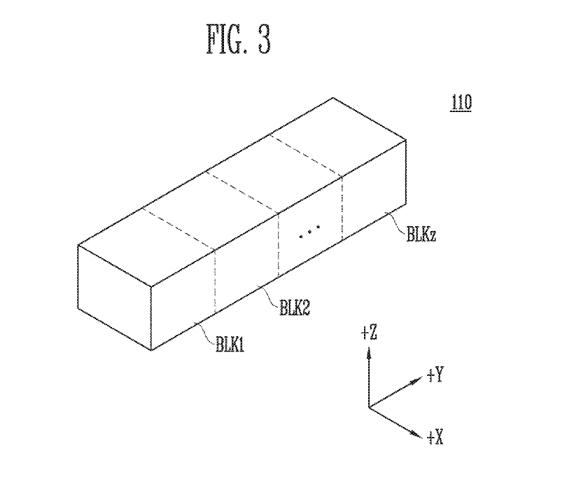

FIG. 3 is a diagram illustrating an embodiment of the memory cell array 110 of FIG. 2.

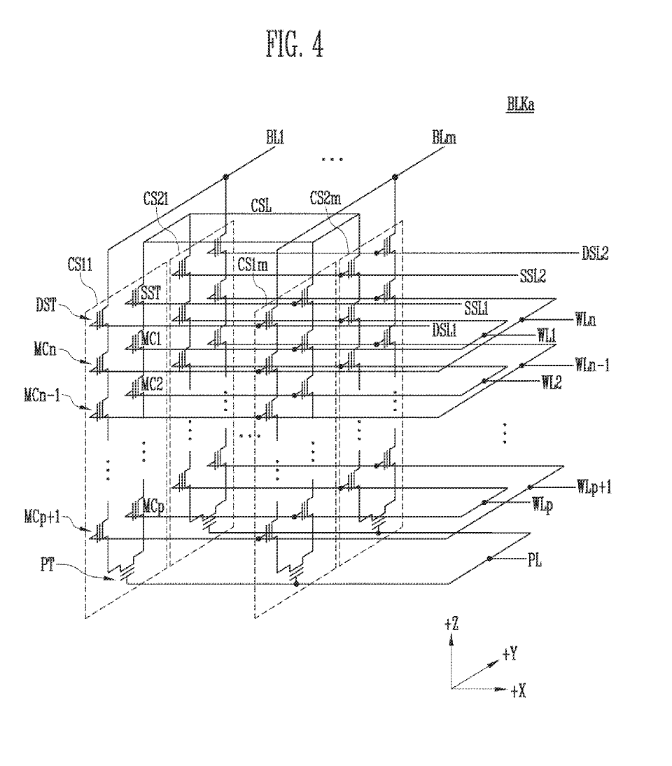

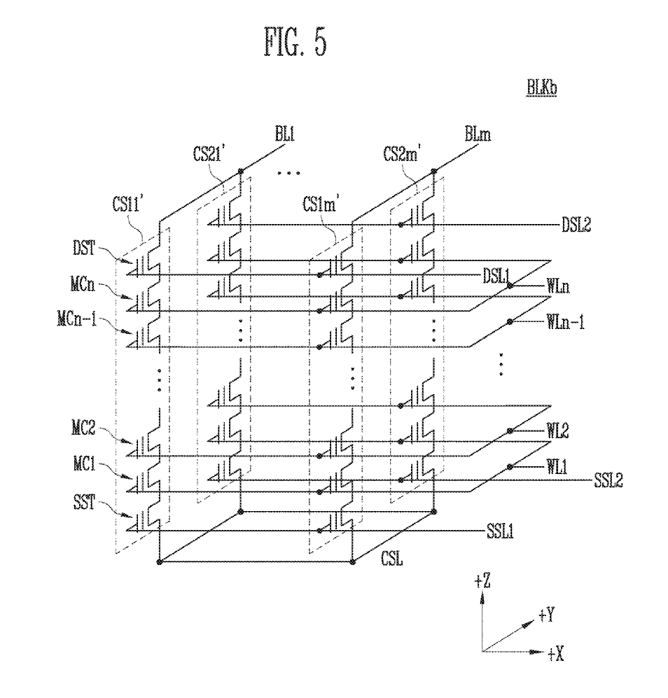

Referring to FIG. 3, the memory cell array 110 may include a plurality of memory blocks BLK1 to BLKz. Each memory block may have a three-dimensional structure. Each memory block may include a plurality of memory cells stacked on a substrate. The memory cells are arranged in a +X direction, a +Y direction, and a +Z direction. The structure of each memory block will be described in with reference to FIGS. 4 and 5.

FIG. 4 is a circuit diagram illustrating any one memory block BLKa of memory blocks BLK1 to BLKz of FIG. 3, in accordance with an embodiment of the present disclosure.

Referring to FIG. 4, the memory block BLKa may include a plurality of cell strings CS11 to CS1m and CS21 to CS2m. In an embodiment, each of the cell strings CS11 to CS1m and CS21 to CS2m may be formed in a ‘U’ shape. In the memory block BLKa, m cell strings may be arranged in a row direction (i.e., the +X direction). In FIG. 4, two cell strings are illustrated as being arranged in a column direction (i.e., the +Y direction). However, this illustration is made for convenience of description, and it will be understood that three or more cell strings may be arranged in the column direction.

Each of the plurality of cell strings CS11 to CS1m and CS21 to CS2m may include at least one source select transistor SST, first to n-th memory cells MC1 to MCn, a pipe transistor PT, and at least one drain select transistor DST.

The select transistors SST and DST and the memory cells MC1 to MCn may have structures similar to each other. In an embodiment, each of the select transistors SST and DST and the memory cells MC1 to MCn may include a channel layer, a tunneling insulating layer, a charge storage layer, and a blocking insulating layer. In an embodiment, a pillar for providing the channel layer may be provided in each cell string. In an embodiment, a pillar for providing at least one of the channel layer, the tunneling insulating layer, the charge storage layer, and the blocking insulating layer may be provided in each cell string.

The source select transistor SST of each cell string is coupled between the common source line CSL and the memory cells MC1 to MCp.

In an embodiment, source select transistors of cell strings arranged in the same row are coupled to a source select line extending in a row direction, and source select transistors of cell strings arranged in different rows are coupled to different source select lines. In FIG. 4, source select transistors of the cell strings CS11 to CS1m in a first row are coupled to a first source select line SSL1. Source select transistors of the cell strings CS21 to CS2m in a second row are coupled to a second source select line SSL2.

In an embodiment, the source select transistors of the cell strings CS11 to CS1m and CS21 to CS2m may be coupled in common to a single source select line.

The first to n-th memory cells MC1 to MCn in each cell string are coupled between the source select transistor SST and the drain select transistor DST.

The first to n-th memory cells MC1 to MCn may be divided into first to p-th memory cells MC1 to MCp and p+1-th to n-th memory cells MCp+1 to MCn. The first to p-th memory cells MC1 to MCp are successively arranged in a direction opposite to the +Z direction and are coupled in series between the source select transistor SST and the pipe transistor PT. The p+1-th to n-th memory cells MCp+1 to MCn are successively arranged in the +Z direction and are coupled in series between the pipe transistor PT and the drain select transistor DST. The first to p-th memory cells MC1 to MCp and the p+1-th to n-th memory cells MCp+1 to MCn are coupled to each other through the pipe transistor PT. The gates of the first to n-th memory cells MC1 to MCn of each cell string are coupled to first to n-th word lines WL1 to WLn, respectively.

A gate of the pipe transistor PT of each cell string is coupled to a pipeline PL.

The drain select transistor DST of each cell string is coupled between the corresponding bit line and the memory cells MCp+1 to MCn. The cell strings arranged in the row direction are coupled to drain select lines extending in the row direction. Drain select transistors of the cell strings CS11 to CS1m in the first row are coupled to a first drain select line DSL1. Drain select transistors of the cell strings CS21 to CS2m in the second row are coupled to a second drain select line DSL2.

Cell strings arranged in the column direction may be coupled to bit lines extending in the column direction. In FIG. 4, cell strings CS11 and CS21 in a first column are coupled to a first bit line BL1. Cell strings CS1m and CS2m in an m-th column are coupled to an m-th bit line BLm.

Memory cells coupled to the same word line in cell strings arranged in the row direction form a single page. For example, memory cells coupled to the first word line WL1, among the cell strings CS11 to CS1m in the first row, form a single page. Memory cells coupled to the first word line WL1, among the cell strings CS21 to CS2m in the second row, form another single page. Cell strings arranged in the direction of a single row may be selected by selecting any one of the drain select lines DSL1 and DSL2. One page may be selected from among the selected cell strings by selecting any one of the word lines WL1 to WLn.

In an embodiment, even bit lines and odd bit lines may be provided in lieu of the first to m-th bit lines BL1 to BLm. Even-number-th cell strings of the cell strings CS11 to CS1m or CS21 to CS2m arranged in the row direction may be coupled to respective even bit lines. Odd-number-th cell strings of the cell strings CS11 to CS1m or CS21 to CS2m arranged in the row direction may be coupled to respective odd bit lines.

In an embodiment, at least one or more of the first to n-th memory cells MC1 to MCn may be used as a dummy memory cell. For example, the at least one or more dummy memory cells may be provided to reduce an electric field between the source select transistor SST and the memory cells MC1 to MCp. Alternatively, the at least one or more dummy memory cells may be provided to reduce an electric field between the drain select transistor DST and the memory cells MCp+1 to MCn. As the number of dummy memory cells is increased, the reliability in operation of the memory block BLKa may be increased, while the size of the memory block BLKa may be increased. As the number of dummy memory cells is reduced, the size of the memory block BLKa may be reduced, but the reliability in operation of the memory block BLKa may be reduced.

To efficiently control the at least one dummy memory cells, each of the dummy memory cells may have a required threshold voltage. Before or after an erase operation on the memory block BLKa is performed, program operations may be performed on all or some of the dummy memory cells. In the case where an erase operation is performed after a program operation has been performed, the dummy memory cells may have required threshold voltages by controlling a voltage to be applied to the dummy word lines coupled to the respective dummy memory cells.

FIG. 5 is a circuit diagram illustrating any one memory block BLKb of the memory blocks BLK1 to BLKz of FIG. 3, in accordance with an embodiment of the present disclosure.

Referring to FIG. 5, the memory block BLKb may include a plurality of cell strings CS11′ to CS1m′ and CS21′ to CS2m′. Each of the cell strings CS11′ to CS1m′ and CS21′ to CS2m′ extends in the +Z direction. Each of the cell strings CS11′ to CS1m′ and CS21′ to CS2m′ may include at least one source select transistor SST, first to n-th memory cells MC1 to MCn, and at least one drain select transistor DST which are stacked on a substrate (not shown) provided in a lower portion of the memory block BLK1′.

The source select transistor SST of each cell string is coupled between the common source line CSL and the memory cells MC1 to MCn. The source select transistors of cell strings arranged in the same row are coupled to the same source select line. Source select transistors of the cell strings CS11′ to CS1m′ arranged in a first row may be coupled to a first source select line SSL1. Source select transistors of the cell strings CS21′ to CS2m′ arranged in a second row may be coupled to a second source select line SSL2. In an embodiment, source select transistors of the cell strings CS11′ to CS1m′ and CS21′ to CS2m′ may be coupled in common to a single source select line.

The first to n-th memory cells MC1 to MCn in each cell string are coupled in series between the source select transistor SST and the drain select transistor DST. Gates of the first to n-th memory cells MC1 to MCn are respectively coupled to first to n-th word lines WL1 to WLn.

The drain select transistor DST of each cell string is coupled between the corresponding bit line and the memory cells MC1 to MCn. Drain select transistors of cell strings arranged in the row direction may be coupled to drain select lines extending in the row direction. Drain select transistors of the cell strings CS11′ to CS1m′ in the first row are coupled to a first drain select line DSL1. Drain select transistors of the cell strings CS21′ to CS2m′ in the second row may be coupled to a second drain select line DSL2.

Consequentially, the memory block BLKb of FIG. 5 may have an equivalent circuit similar to that of the memory block BLKa of FIG. 4 except that a pipe transistor PT is excluded from each cell string.

In an embodiment, even bit lines and odd bit lines may be provided in lieu of the first to m-th bit lines BL1 to BLm. Even-number-th cell strings among the cell strings CS11′ to CS1m′ or CS21′ to CS2m′ arranged in the row direction may be coupled to the respective even bit lines, and odd-number-th cell strings among the cell strings CS11′ to CS1m′ or CS21′ to CS2m′ arranged in the row direction may be coupled to the respective odd bit lines.

In an embodiment, at least one or more of the first to n-th memory cells MC1 to MCn may be used as a dummy memory cell. For example, the at least one or more dummy memory cells may be provided to reduce an electric field between the source select transistor SST and the memory cells MC1 to MCn. Alternatively, the at least one or more dummy memory cells may be provided to reduce an electric field between the drain select transistor DST and the memory cells MC1 to MCn. As the number of dummy memory cells is increased, the reliability in operation of the memory block BLKb may be increased, while the size of the memory block BLKb may be increased. As the number of dummy memory cells is reduced, the size of the memory block BLKb may be reduced, but the reliability in operation of the memory block BLKb may be reduced.

To efficiently control the at least one dummy memory cells, each of the dummy memory cells may have a required threshold voltage. Before or after an erase operation on the memory block BLKb is performed, program operations may be performed on all or some of the dummy memory cells. In the case where an erase operation is performed after a program operation has been performed, the dummy memory cells may have required threshold voltages by controlling a voltage to be applied to the dummy word lines coupled to the respective dummy memory cells.

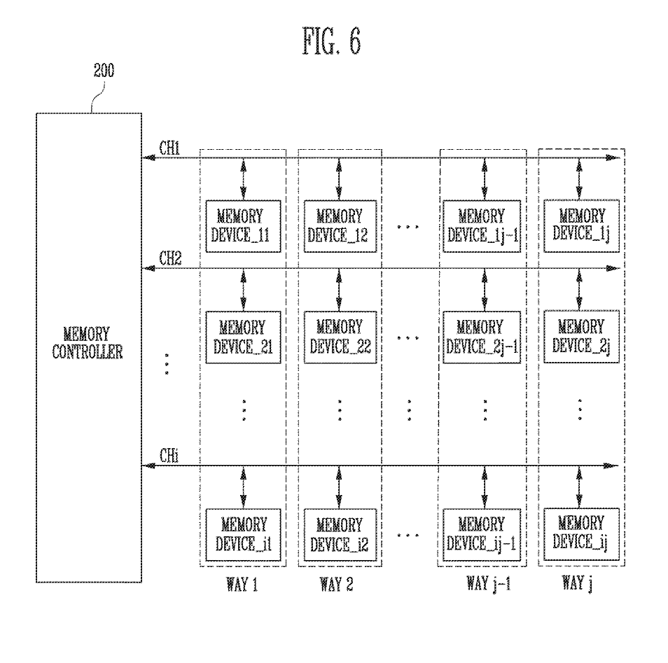

FIG. 6 is a block diagram illustrating an embodiment of connection relationship between the memory controller 200 and a plurality of memory devices of FIG. 1.

Referring to FIG. 6, the memory controller 200 may be coupled with a plurality of memory devices (memory device_11 to memory device_ij) through a plurality of channels CH0 to CHi. In an embodiment, it is to be noted that the number of channels or memory devices coupled to each channel may be changed in various ways. In an embodiment, ‘i’ is a natural number and ‘j’ is a natural number.

Memory device_11 to memory device_1j may be coupled in common to channel 1 CH1. Memory device_11 to memory device_1j may communicate with the memory controller 200 through channel 1 CH1. Since memory device_11 to memory device_1j are coupled in common to channel 1 CH1, only one memory device may communicate with the memory controller 200 at a time. However, respective internal operations of memory device_11 to memory device_1j may be performed at the same time.

Memory devices coupled to channel 2 CH2 to channel i CHi may also be operated in the same manner as those of the memory devices coupled to above-mentioned channel 1 CH1.

In the storage device using a plurality of memory devices, the performance may be enhanced using data interleaving which is data communication using an interleave scheme. In a structure in which two or more ways share a single channel, the data interleaving may be to perform a read or write operation while changing the ways. For the data interleaving, the memory devices may be managed on a channel and way basis. To maximize parallelization of the memory devices coupled to each channel, the memory controller 200 may disperse and allocate successive logical memory regions to the channel and the ways.

For example, the memory controller 200 may transmit a command, a control signal including an address, and data to memory device_11 through channel 1 CH1. While memory device_11 programs the transmitted data to memory cells included therein, the memory controller 200 may transmit a command, a control signal including an address, and data to memory device_12.

Referring to FIG. 6, the plurality of memory devices may be configured of j ways WAY1 to WAYj. Way 1 WAY1 may include memory device_11 to memory device_i1. Memory devices included in way 2 WAY2 to way j WAY j may also be configured in the same manner as those of the memory devices included in above-mentioned way 1 WAY1.

Each of the channels CH1 to CHi may be a bus for signals which is shared by the memory devices coupled to the corresponding channel. Although in FIG. 6 there has been described the case where the data interleaving is applied to an i-channel/i-way structure, the efficiency of the interleaving may be increased as the number of channels and the number of ways are increased.

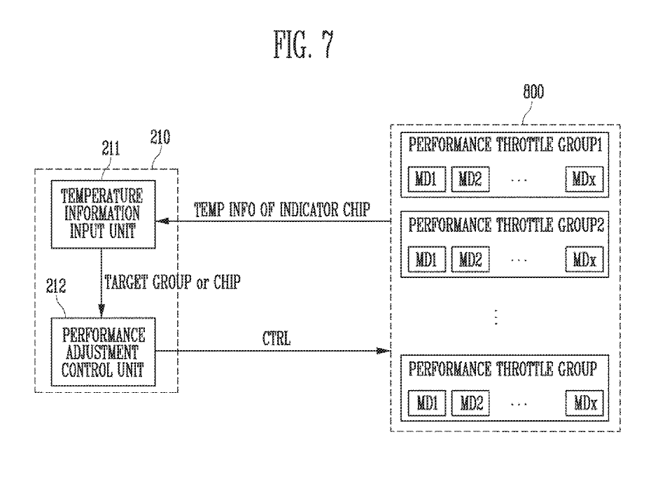

FIG. 7 is a diagram for describing the operation of the performance adjustment unit 210 of FIG. 1.

Referring to FIG. 7, the performance adjustment unit 210 may include a temperature information input unit 211 and a performance adjustment control unit 212. In an embodiment, the temperature information input unit 211 may be implemented with software, hardware, or any combination thereof. In an embodiment, the performance adjustment control unit 212 may be implemented with software, hardware, or any combination thereof.

Memory devices 800 which are controlled by the memory controller may be divided into a plurality of performance throttle groups. For example, the memory devices 800 may be divided into performance throttle group 1 to performance throttle group k (i.e., ‘k’ is a natural number). Each performance throttle group may include a first memory device MD1 to an x-th memory device MDx (i.e., ‘x’ is a natural number). Although in FIG. 7 there is illustrated the case where each performance throttle group includes the same number of memory devices, embodiments of the present disclosure are not limited to the embodiment of FIG. 7.

Each of performance throttle group 1 to performance throttle group k may include a single indicator chip. The indicator chip may be a memory device representing the corresponding performance throttle group. The performance adjustment unit 210 may treat the temperature information of the indicator chip as the temperature information of the corresponding performance throttle group. In an embodiment, the indicator chip may be determined based on physical locations of the memory devices included in the corresponding performance throttle group.

In various embodiments, each performance throttle group may include at least two or more indicator chips.

The temperature information input unit 211 may obtain temperature information from the plurality of memory devices 800. For example, the indicator chip included in each of performance throttle group 1 to performance throttle group k may provide, to the temperature information input unit 211, temperature information including information about a temperature measured by the temperature sensor included in the indicator chip.

The temperature information input unit 211 may detect a performance limit group, which is a group on which a performance throttling operation is to be performed, based on the temperature information of the indicator chips. For example, the temperature information input unit 211 may determine whether an indicator chip the temperature of which exceeds the threshold temperature is present, based on the temperature information of the indicator chips. The temperature information input unit 211 may determine a performance throttle group including the indicator chip the temperature of which exceeds the threshold temperature, to be a performance limit group.

In various embodiments, the temperature information input unit 211 may receive temperature information from all of the memory devices included in performance throttle group 1 to performance throttle group k (i.e., ‘k’ is a natural number). The temperature information may include a temperature measured by the temperature sensor included in each corresponding memory device, and relevant information.

The temperature information input unit 211 may detect a memory device the temperature of which exceeds the threshold temperature, based on the inputted temperature information, and determine the corresponding memory device to be a performance limit device.

The temperature information input unit 211 may provide information about a performance limit group or a performance limit device to the performance adjustment control unit 212.

The performance adjustment control unit 212 may perform a performance throttling operation on a memory device corresponding to the performance limit device. Alternatively, in an embodiment, the performance adjustment control unit 212 may perform a performance throttling operation on memory devices included in the performance limit group. In an embodiment, the performance adjustment control unit 212 may limit, for a preset time, power to be supplied to the memory device corresponding to the performance limit device or the memory devices included in the performance limit group.

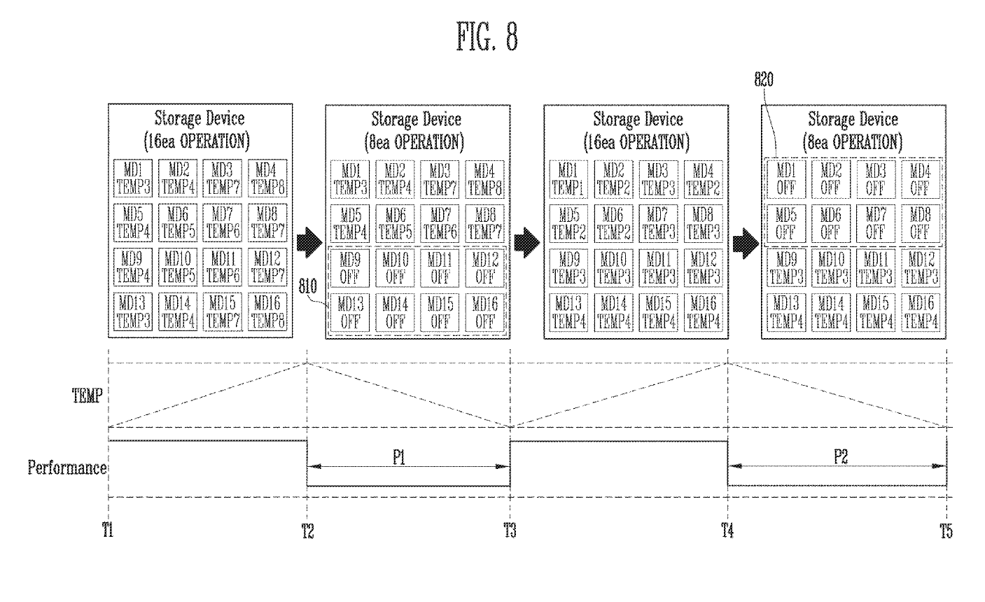

FIG. 8 is a diagram for describing an operation of throttling the performance depending on the temperature in a storage device.

Referring to FIG. 8, it is assumed that the storage device controls sixteen memory devices MD. The reason for this is only for convenience in explanation, and the storage device may control more than sixteen memory devices. Furthermore, in FIG. 8, the temperatures of the memory devices are expressed in eight steps including TEMP1 to TEMP8. TEMP1 indicates the highest temperature, and TEMP8 indicates the lowest temperature.

During a period from T1 to T2, a first memory device MD1 disposed on a first row in the storage device has a temperature corresponding to TEMP3, a second memory device MD2 has a temperature corresponding to TEMP4, a third memory device MD3 has a temperature corresponding to TEMP7, and a fourth memory device MD4 has a temperature corresponding to TEMP8.

A fifth memory device MD5 disposed on a second row has a temperature corresponding to TEMP4, a sixth memory device MD6 has a temperature corresponding to TEMP5, a seventh memory device MD7 has a temperature corresponding to TEMP6, and an eighth memory device MD8 has a temperature corresponding to TEMP7.

A ninth memory device MD9 disposed on a third row has a temperature corresponding to TEMP4, a tenth memory device MD10 has a temperature corresponding to TEMP5, an eleventh memory device MD11 has a temperature corresponding to TEMP6, and a twelfth memory device MD12 has a temperature corresponding to TEMP7.

A thirteenth memory device MD13 disposed on a fourth row has a temperature corresponding to TEMP3, a fourteenth memory device MD14 has a temperature corresponding to TEMP4, a fifteenth memory device MD15 has a temperature corresponding to TEMP7, and a sixteenth memory device MD16 has a temperature corresponding to TEMP8.

Due to the operation of the storage device during the period from T1 to T2, the temperature of the storage device including the first to sixteenth memory devices MD1 to MD16 may increase. During the period from T1 to T2, the storage device has performance with which all of the sixteen memory devices are operated.

At time T2, a performance throttling operation may be performed. The storage device may limit power to be applied, in detail, to eight memory devices included in a lower region 810. For example, the storage device may control the ninth to sixteenth memory devices MD9 to MD16 such that they are turned off for a preset time. During a period from T2 to T3, the storage device has performance with which eight memory devices are operated.

In this case, there may be a problem in that, despite the fact that the temperatures of the eleventh memory device MD11, the twelfth memory device MD12, the fifteenth memory device MD15, and the sixteenth memory device MD16 are actually comparatively low, they are turned off. Furthermore, the first memory device MD1, the second memory device MD2, the fifth memory device MD5, and the sixth memory device MD6 might not be turned off despite the fact that they have temperatures higher than those of the other memory devices.

At time T3, the performance of the storage device may be restored. In other words, during a period from T3 to T4, the storage device has the performance with which all of the sixteen memory devices are operated.

During the period from T3 to T4, the first memory device MD1 disposed on the first row in the storage device has a temperature corresponding to TEMP1, the second memory device MD2 has a temperature corresponding to TEMP2, the third memory device MD3 has a temperature corresponding to TEMP3, and the fourth memory device MD4 has a temperature corresponding to TEMP2.

The fifth memory device MD5 disposed on the second row has a temperature corresponding to TEMP2, the sixth memory device MD6 has a temperature corresponding to TEMP2, the seventh memory device MD7 has a temperature corresponding to TEMP3, and the eighth memory device MD8 has a temperature corresponding to TEMP3.

The ninth memory device MD9 disposed on the third row has a temperature corresponding to TEMP3, the tenth memory device MD10 has a temperature corresponding to TEMP3, the eleventh memory device MD11 has a temperature corresponding to TEMP3, and the twelfth memory device MD12 has a temperature corresponding to TEMP3.

The thirteenth memory device MD13 disposed on the fourth row has a temperature corresponding to TEMP4, the fourteenth memory device MD14 has a temperature corresponding to TEMP4, the fifteenth memory device MD15 has a temperature corresponding to TEMP4, and the sixteenth memory device MD16 has a temperature corresponding to TEMP4.

At time T4, a performance throttling operation may be performed. The storage device may limit power to be applied, in detail, to eight memory devices included in an upper region 820. For example, the storage device may control the first to eighth memory devices MD1 to MD8 such that they are turned off for a preset time. During a period from T4 to T5, the storage device has the performance with which eight memory devices are operated.

In this case, there is a problem in that, despite the fact that the temperatures of all of the first to twelfth memory devices MD1 to MD12 exceed TEMP4 that is a threshold temperature, only the first to eight memory devices MD1 to MD8 are turned off.

In the performance throttling operation described with reference to FIG. 8, the memory devices included in the preset upper or lower region 820 or 810 are uniformly turned off regardless of actual temperatures of the memory devices. Hence, it takes a relatively long time to cool a memory device the temperature of which has excessively increased. Thereby, it may be difficult to maintain high performance.

For example, in the storage device of FIG. 8, because the performance throttling operation has not been performed on the first memory device MD1 at an appropriate time, the first memory device MD1 has reached TEMP8 that is the highest temperature. Consequently, the time required to reduce the temperature of the first memory device MD1 may increase (P1<P2).

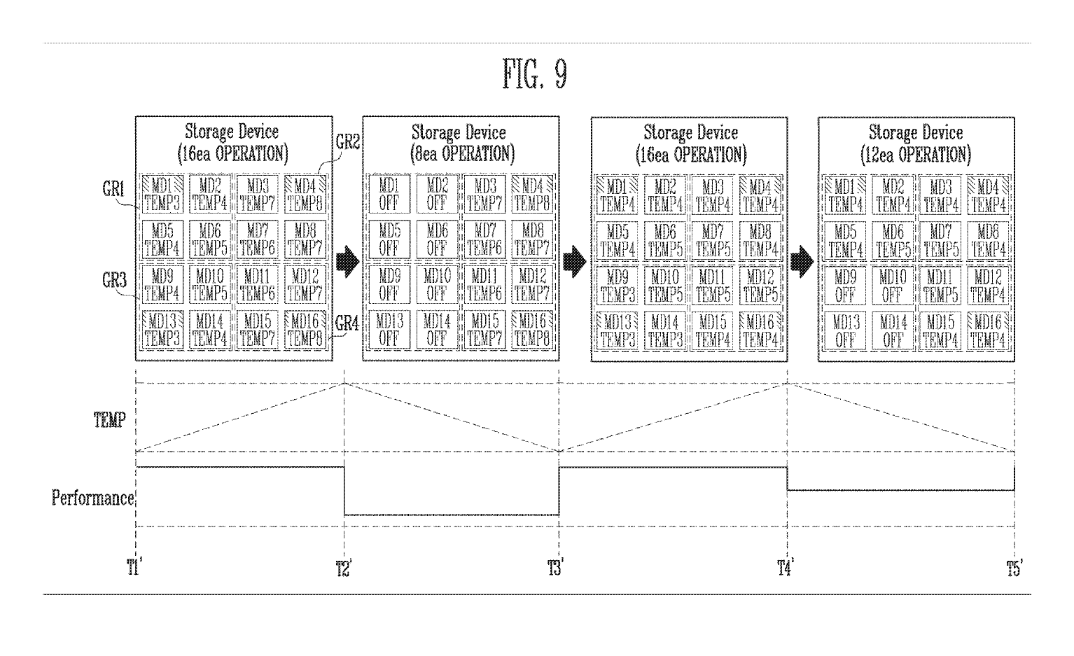

FIG. 9 is a diagram for describing a performance throttling operation in accordance with an embodiment of the present disclosure.

Referring to FIG. 9, the storage device controls sixteen memory devices MD.

During a period from T1′ to T2′, a first memory device MD1 disposed on a first row in the storage device has a temperature corresponding to TEMP3, a second memory device MD2 has a temperature corresponding to TEMP4, a third memory device MD3 has a temperature corresponding to TEMP7, and a fourth memory device MD4 has a temperature corresponding to TEMP8.

A fifth memory device MD5 disposed on a second row has a temperature corresponding to TEMP4, a sixth memory device MD6 has a temperature corresponding to TEMP5, a seventh memory device MD7 has a temperature corresponding to TEMP6, and an eighth memory device MD8 has a temperature corresponding to TEMP7.

A ninth memory device MD9 disposed on a third row has a temperature corresponding to TEMP4, a tenth memory device MD10 has a temperature corresponding to TEMP5, an eleventh memory device MD11 has a temperature corresponding to TEMP6, and a twelfth memory device MD12 has a temperature corresponding to TEMP7.

A thirteenth memory device MD13 disposed on a fourth row has a temperature corresponding to TEMP3, a fourteenth memory device MD14 has a temperature corresponding to TEMP4, a fifteenth memory device MD15 has a temperature corresponding to TEMP7, and a sixteenth memory device MD16 has a temperature corresponding to TEMP8.

Due to the operation of the storage device during the period from T1′ to T2′, the temperature of the storage device including the first to sixteenth memory devices MD1 to MD16 may increase. During the period from T1′ to T2′, the storage device has performance with which all of the sixteen memory devices are operated.

In accordance with an embodiment of the present disclosure, the plurality of memory devices included in the storage device may be divided into a plurality of performance throttle groups. For example, the first memory device MD1, the second memory device MD2, the fifth memory device MD5, and the sixth memory device MD6 may be included in performance throttle group 1 GR1. The third memory device MD3, the fourth memory device MD4, the seventh memory device MD7, and the eighth memory device MD8 may be included in performance throttle group 2 GR2. The ninth memory device MD9, the tenth memory device MD10, the thirteenth memory device MD13, and the fourteenth memory device MD14 may be included in performance throttle group 3 GR3. The eleventh memory device MD11, the twelfth memory device MD12, the fifteenth memory device MD15, and the sixteenth memory device MD16 may be included in performance throttle group 4 GR4. Each performance throttle group may include an indicator chip representing the corresponding performance throttle group. For example, the indicator chip of performance throttle group 1 GR1 may be the first memory device MD1. The indicator chip of performance throttle group 2 GR2 may be the fourth memory device MD2. The indicator chip of performance throttle group 3 GR3 may be the thirteenth memory device MD13. The indicator chip of performance throttle group 4 GR4 may be the sixteenth memory device MD16.

At time T2′, if the temperature of the storage device increases, the memory controller may receive temperature information of the indicator chips. The memory controller may determine whether a memory device the temperature of which exceeds TEMP4 that is the threshold temperature is present, based on the temperature information of the indicator chips. As a result of the determination, it may be determined that the first memory device MD1 and the thirteenth memory device MD13 have temperatures higher than the threshold temperature TEMP4. The storage device may turn off the memory devices included in performance throttle group 1 and performance throttle group 3 that include the corresponding indicator chips.

At time T3′, the performance of the storage device may be restored. In other words, during a period from T3′ to T4′, the storage device has the performance with which all of the sixteen memory devices are operated.

During the period from T3′ to T4′, the first memory device MD1 disposed on the first row in the storage device has a temperature corresponding to TEMP4, the second memory device MD2 has a temperature corresponding to TEMP4, the third memory device MD3 has a temperature corresponding to TEMP4, and the fourth memory device MD4 has a temperature corresponding to TEMP4.

The fifth memory device MD5 disposed on the second row has a temperature corresponding to TEMP4, the sixth memory device MD6 has a temperature corresponding to TEMP5, the seventh memory device MD7 has a temperature corresponding to TEMP5, and the eighth memory device MD8 has a temperature corresponding to TEMP4.

The ninth memory device MD9 disposed on the third row has a temperature corresponding to TEMP3, the tenth memory device MD10 has a temperature corresponding to TEMP5, the eleventh memory device MD11 has a temperature corresponding to TEMP5, and the twelfth memory device MD12 has a temperature corresponding to TEMP5.

The thirteenth memory device MD13 disposed on the fourth row has a temperature corresponding to TEMP3, the fourteenth memory device MD14 has a temperature corresponding to TEMP3, the fifteenth memory device MD15 has a temperature corresponding to TEMP4, and the sixteenth memory device MD16 has a temperature corresponding to TEMP4.

At time T4′, a performance throttling operation may be performed. The memory controller may receive temperature information of the indicator chips. The memory controller may determine whether a memory device the temperature of which exceeds TEMP4 that is the threshold temperature is present, based on the temperature information of the indicator chips. As a result of the determination, it may be determined that the thirteenth memory device MD13 has a temperature higher than the threshold temperature TEMP4. The storage device may turn off the memory devices included in performance throttle group 3 that includes the corresponding indicator chip. Therefore, during a period from T4′ to T5′, the storage device may have performance with which twelve memory devices are operated.

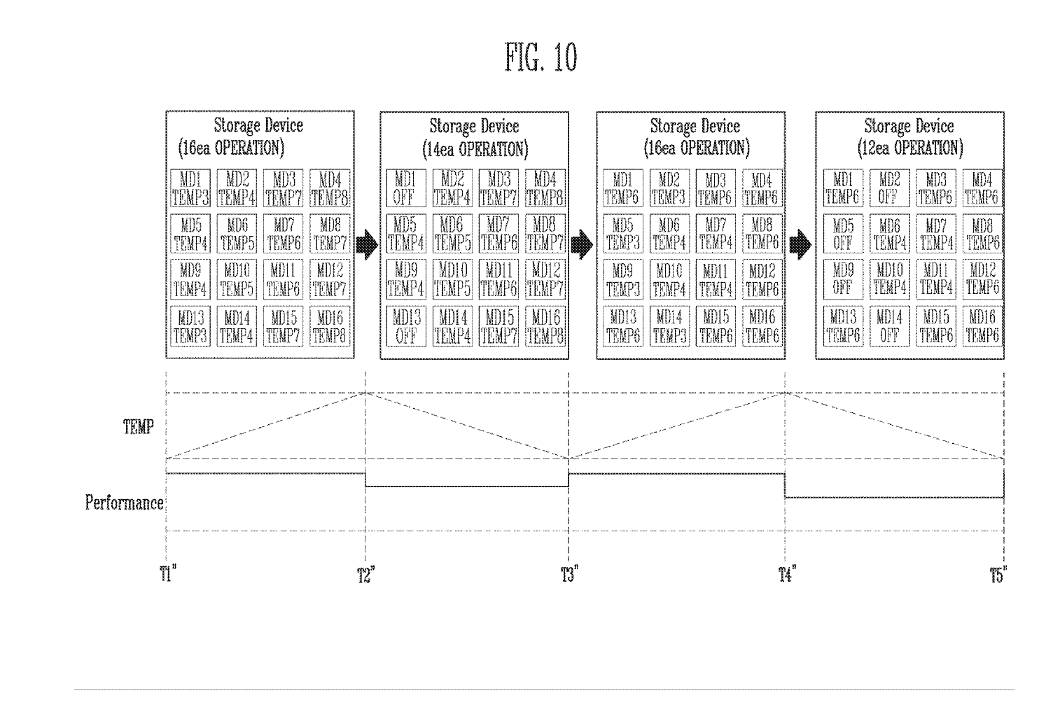

FIG. 10 is a diagram for describing a performance throttling operation in accordance with an embodiment of the present disclosure.

Referring to FIG. 10, the storage device controls sixteen memory devices MD.

During a period from T1″ to T2″, a first memory device MD1 disposed on a first row in the storage device has a temperature corresponding to TEMP3, a second memory device MD2 has a temperature corresponding to TEMP4, a third memory device MD3 has a temperature corresponding to TEMP7, and a fourth memory device MD4 has a temperature corresponding to TEMP8.

A fifth memory device MD5 disposed on a second row has a temperature corresponding to TEMP4, a sixth memory device MD6 has a temperature corresponding to TEMP5, a seventh memory device MD7 has a temperature corresponding to TEMP6, and an eighth memory device MD8 has a temperature corresponding to TEMP7.

A ninth memory device MD9 disposed on a third row has a temperature corresponding to TEMP4, a tenth memory device MD10 has a temperature corresponding to TEMP5, an eleventh memory device MD11 has a temperature corresponding to TEMP6, and a twelfth memory device MD12 has a temperature corresponding to TEMP7.

A thirteenth memory device MD13 disposed on a fourth row has a temperature corresponding to TEMP3, a fourteenth memory device MD14 has a temperature corresponding to TEMP4, a fifteenth memory device MD15 has a temperature corresponding to TEMP7, and a sixteenth memory device MD16 has a temperature corresponding to TEMP8.

Due to the operation of the storage device during the period from T1″ to T2″, the temperature of the storage device including the first to sixteenth memory devices MD1 to MD16 may increase. During the period from T1″ to T2″, the storage device has performance with which all of the sixteen memory devices are operated.

In accordance with the present embodiment, the memory controller may obtain temperature information of each of the plurality of memory devices included in the storage device. In other words, the memory controller may obtain temperature information of each of the first to sixteenth memory devices MD1 to MD16. The memory controller may set a memory device the temperature of which exceeds TEMP4 that is the threshold temperature, as a performance limit device, based on the temperature information of each memory device. Referring to FIG. 10, the temperatures of the first memory device MD1 and the thirteenth memory device MD13 are TEMP3 exceeding the threshold temperature. Therefore, the memory controller may turn off the first memory device MD1 and the thirteenth memory device MD13 that correspond to the performance limit device.

At time T3″, the performance of the storage device may be restored. In other words, during a period from T3″ to T4″, the storage device has the performance with which all of the sixteen memory devices are operated.

During the period from T3″ to T4″, the first memory device MD1 disposed on the first row in the storage device has a temperature corresponding to TEMP6, the second memory device MD2 has a temperature corresponding to TEMP3, the third memory device MD3 has a temperature corresponding to TEMP6, and the fourth memory device MD4 has a temperature corresponding to TEMP6.

The fifth memory device MD5 disposed on the second row has a temperature corresponding to TEMP3, the sixth memory device MD6 has a temperature corresponding to TEMP4, the seventh memory device MD7 has a temperature corresponding to TEMP4, and the eighth memory device MD8 has a temperature corresponding to TEMP6.

The ninth memory device MD9 disposed on the third row has a temperature corresponding to TEMP3, the tenth memory device MD10 has a temperature corresponding to TEMP4, the eleventh memory device MD11 has a temperature corresponding to TEMP4, and the twelfth memory device MD12 has a temperature corresponding to TEMP6.

The thirteenth memory device MD13 disposed on the fourth row has a temperature corresponding to TEMP6, the fourteenth memory device MD14 has a temperature corresponding to TEMP3, the fifteenth memory device MD15 has a temperature corresponding to TEMP6, and the sixteenth memory device MD16 has a temperature corresponding to TEMP6.

At time T4″, a performance throttling operation may be performed. The memory controller may obtain temperature information from each of the first to sixteenth memory devices MD1 to MD16, and selectively turn off only the second memory device MD2, the fifth memory device MD5, the ninth memory device MD9, and the fourteenth memory device MD14 that are memory devices the temperatures of which exceed the threshold temperature.

In accordance with the embodiment of FIG. 10, the storage device may have, during the period from T1″ to T2″, performance with which sixteen memory devices are operated, may have, during the period from T2″ to T3″, performance with which fourteen memory devices are operated, may have, during the period from T3″ to T4″, performance with which sixteen memory devices are operated, and may have, during the period from T4″ to T5″, performance with which twelve memory devices are operated. In accordance with the embodiment of FIG. 10, since the performance throttling operation is performed on only a memory device the temperature of which exceeds the threshold temperature, the high performance of the storage device may be maintained.

FIG. 11 is a flowchart for explaining an operation of the storage device in accordance with an embodiment of the present disclosure.

Referring to FIG. 11, at step S1101, the storage device may obtain temperature information from the indicator chips.

At step S1103, the storage device may determine whether an indicator chip the temperature of which exceeds the threshold temperature is present. As a result of the determination, if an indicator chip the temperature of which exceeds the threshold temperature is present (i.e., YES), the process may proceed to step S1104, or, if not (i.e., NO), the process may be terminated (i.e., END).

At step S1104, the storage device may set a performance throttle group including the indicator chip the temperature of which exceeds the threshold temperature, as a performance limit group, and may perform a performance throttling operation on memory devices included in the corresponding group.

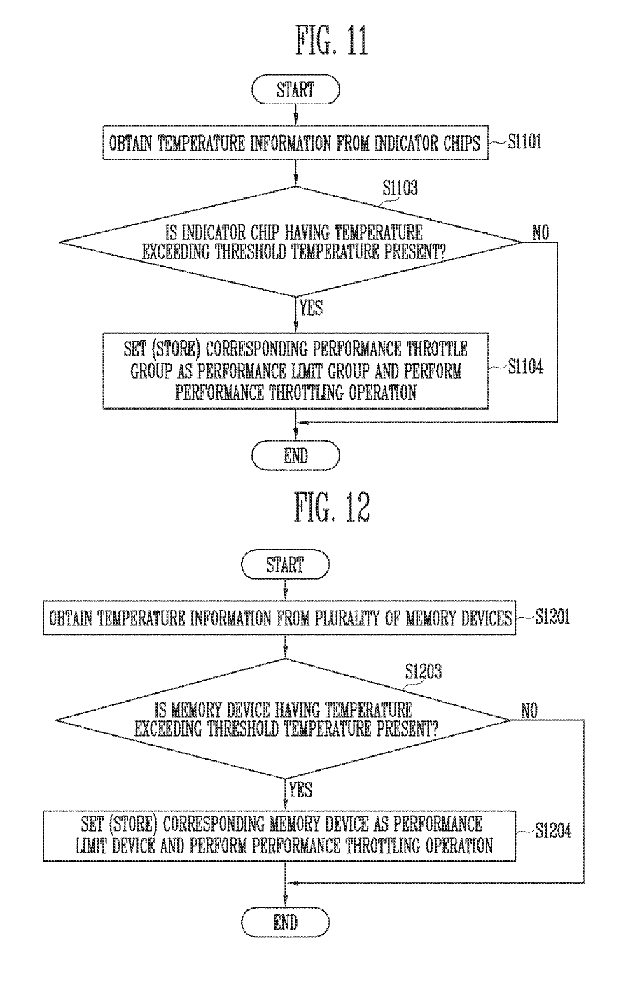

FIG. 12 is a flowchart for explaining an operation of the storage device in accordance with an embodiment of the present disclosure.

Referring to FIG. 12, at step S1201, the storage device may obtain temperature information from a plurality of memory devices.

At step S1203, the storage device may determine whether a memory device the temperature of which exceeds the threshold temperature is present. As a result of the determination, if a memory device the temperature of which exceeds the threshold temperature is present (i.e., YES), the process may proceed to step S1204, or, if not (i.e., NO), the process may be terminated (i.e., END).

At step S1204, the storage device may set a memory device the temperature of which exceeds the threshold temperature, as a performance limit device, and perform a performance throttling operation on the corresponding memory device.

FIG. 13 is a diagram for explaining an embodiment of the memory controller 200 of FIG. 1.

A memory controller 1000 is coupled to a host and a memory device. In response to a request from the host, the memory controller 1000 may access the memory device. For example, the memory controller 1000 may control a write operation, a read operation, an erase operation, and a background operation of the memory device. The memory controller 1000 may provide an interface between the memory device and the host. The memory controller 1000 may drive firmware for controlling the memory device.

Referring to FIG. 13, the memory controller 1000 may include a processor 1010, a memory buffer 1020, an error correction code (ECC) circuit 1030, a host Interface 1040, a buffer control circuit 1050, a memory interface 1060, and a bus 1070.

The bus 1070 may provide a channel between the components of the memory controller 1000.

The processor 1010 may control the overall operation of the memory controller 1000 and perform a logical operation. The processor 1010 may communicate with the external host through the host interface 1040, and communicate with the memory device 100 through the memory interface 1060. In addition, the processor 1010 may communicate with the memory buffer 1020 through the buffer control circuit 1050. The processor 1010 may control the operation of the storage device 50 using the memory buffer 1020 as an operation memory, a cache memory, or a buffer memory.

The processor 1010 may perform the function of a flash translation layer (FTL). The processor 1010 may translate a logical block address (LBA), provided by the host, into a physical block address (PBA) through the FTL. The FTL may receive the LBA using a mapping table and translate the LBA into the PBA. An address mapping method using the FTL may be modified in various ways based on the unit of mapping. Representative address mapping methods may include a page mapping method, a block mapping method, and a hybrid mapping method.

The processor 1010 may randomize data received from the host. For example, the processor 1010 may use a randomizing seed to randomize data received from the host. Randomized data may be provided to the memory device 100 as data to be stored, and may be programmed to the memory cell array.

During a read operation, the processor 1010 may derandomize data received from the memory device 100. For example, the processor 1010 may use a derandomizing seed to derandomize data received from the memory device 100. Derandomized data may be output to the host.

In an embodiment, the processor 1010 may drive software or firmware to perform the randomizing operation or the derandomizing operation.

The memory buffer 1020 may be used as an operation memory, a cache memory, or a buffer memory of the processor 1010. The memory buffer 1020 may store codes and commands to be executed by the processor 1010. The memory buffer 1020 may store data to be processed by the processor 1010. The memory buffer 1020 may include a static RAM (SRAM) or a dynamic RAM (DRAM).

The ECC circuit 1030 may perform error correction. The ECC circuit 1030 may perform an ECC encoding operation based on data to be written to the memory device 100 through the memory interface 1060. ECC encoded data may be transmitted to the memory device 100 through the memory interface 1060. The ECC circuit 1030 may perform an ECC decoding operation on data received from the memory device 100 through the memory interface 1060. For example, the ECC circuit 1030 may be included in the memory interface 1060 as a component of the memory interface 1060.

The host interface 1040 may communicate with the external host under control of the processor 1010. The host interface 1040 may perform communication using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), multiMedia card (MMC), an embedded MMC (eMMC), a dual in-line memory module (DIMM), a registered DIMM (RDIMM), and a load reduced DIMM (LRDIMM), etc.

The buffer control circuit 1050 may control the memory buffer 1020 under control of the processor 1010.

The memory interface 1060 may communicate with the memory device 100 under control of the processor 1010. The memory interface 1060 may communicate a command, an address, and data with the memory device 100 through the channel.

For example, the memory controller 1000 may include neither the memory buffer 1020 nor the buffer control circuit 1050.

For example, the processor 1010 may use codes to control the operation of the memory controller 1000. The processor 1010 may load codes from a nonvolatile memory device (e.g., a read only memory) provided in the memory controller 1000. Alternatively, the processor 1010 may load codes from the memory device 100 through the memory interface 1060.

For example, the bus 1070 of the memory controller 1000 may be divided into a control bus and a data bus. The data bus may transmit data in the memory controller 1000. The control bus may transmit control information such as a command and an address in the memory controller 1000. The data bus and the control bus may be separated from each other and may neither interfere with each other nor affect each other. The data bus may be coupled to the host interface 1040, the buffer control circuit 1050, the ECC circuit 1030, and the memory interface 1060. The control bus may be coupled to the host interface 1040, the processor 1010, the buffer control circuit 1050, the memory buffer 1020, and the memory interface 1060.

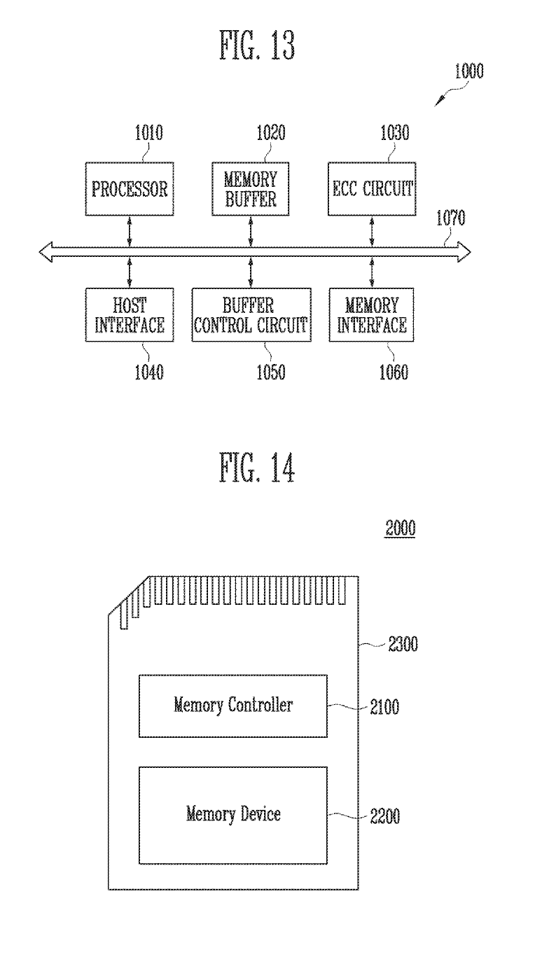

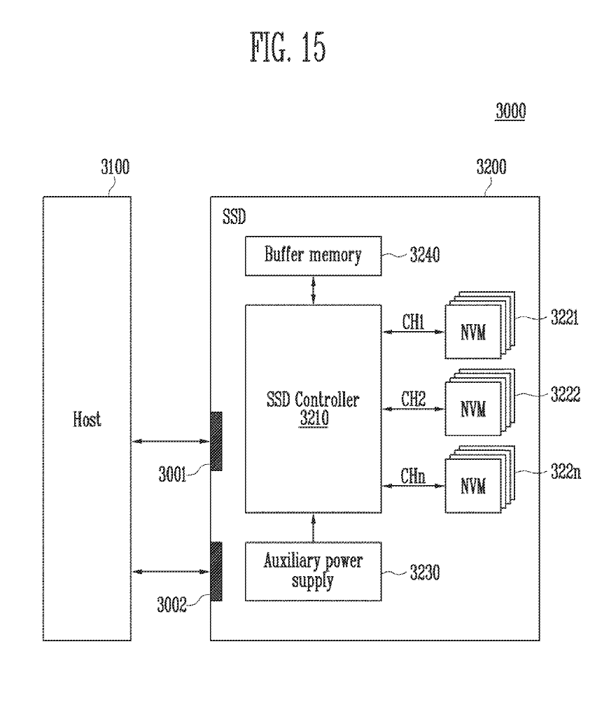

FIG. 14 is a block diagram illustrating a memory card system 2000 to which a storage device in accordance with an embodiment of the present disclosure is applied.

Referring FIG. 14, the memory card system 2000 may include a memory controller 2100, a memory device 2200 and a connector 2300.

The memory controller 2100 is coupled to the memory device 2200. The memory controller 2100 may access the memory device 2200. For example, the memory controller 2100 may control a read operation, a write operation, an erase operation, and a background operation of the memory device 2200. The memory controller 2100 may provide an interface between the memory device 2100 and the host. The memory controller 2100 may drive firmware for controlling the memory device 2200. The memory controller 2100 may be embodied in the same manner as that of the memory controller 200 described with reference to FIG. 1.

In an embodiment, the memory controller 2100 may include components such as a random access memory (RAM), a processing unit, a host interface, and a memory interface, and an ECC circuit, etc.

The memory controller 2100 may communicate with an external device through the connector 2300. The memory controller 2100 may communicate with an external device (e.g., a host) based on a specific communication protocol. In an embodiment, the memory controller 2100 may communicate with the external device through at least one of various communication protocols such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer small interface (SCSI), enhanced small disk interface (ESDI), integrated drive electronics (IDE), Firewire, universal flash storage (UFS), Wi-Fi, Bluetooth, and nonvolatile memory express (NVMe) protocols, etc. In an embodiment, the connector 2300 may be defined by at least one of the above-described various communication protocols.

In an embodiment, the memory device 2200 may be implemented as any of various nonvolatile memory devices, such as an electrically erasable and programmable ROM (EEPROM), a NAND flash memory, a NOR flash memory, a phase-change RAM (PRAM), a resistive RAM (ReRAM), a ferroelectric RAM (FRAM), and a spin-torque magnetic RAM (ST-MRAM), etc.

In an embodiment, the memory controller 2100 and the memory device 2200 may be integrated into a single semiconductor device to form a memory card. For example, the memory controller 2100 and the memory device 2200 may be integrated into a single semiconductor device to form a memory card such as a personal computer memory card international association (PCMCIA), a compact flash card (CF), a smart media card (SM or SMC), a memory stick, a multimedia card (MMC, RS-MMC, or MMCmicro), a SD card (SD, miniSD, microSD, or SDHC), or a universal flash storage (UFS), etc.

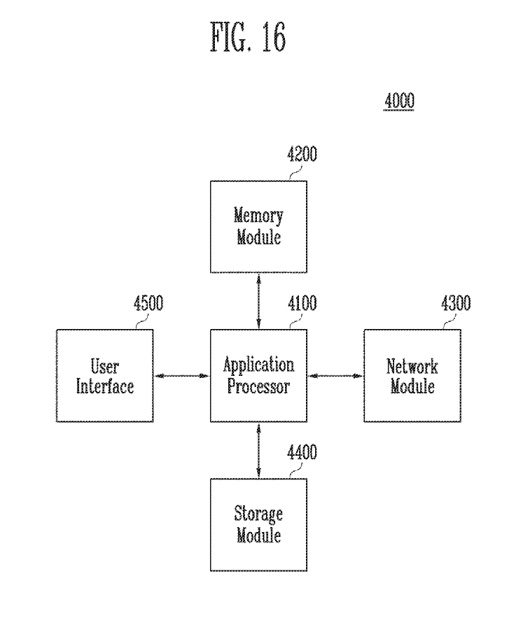

FIG. 15 is a block diagram illustrating a solid state drive (SSD) system 3000 to which the storage device in accordance with an embodiment of the present disclosure is applied.

Referring to FIG. 15, the SSD system 3000 may include a host 3100 and an SSD 3200. The SSD 3200 may exchange signals SIG with the host 3100 through a signal connector 3001 and may receive power PWR through a power connector 3002. The SSD 3200 may include an SSD controller 3210, a plurality of flash memories 3221 to 322n, an auxiliary power supply 3230, and a buffer memory 3240.

In an embodiment, the SSD controller 3210 may perform the function of the memory controller 200, described above with reference to FIG. 1.

The SSD controller 3210 may control the plurality of flash memories 3221 to 322n in response to the signals SIG received from the host 3100. In an embodiment, the signals SIG may be signals based on the interfaces of the host 3100 and the SSD 3200. For example, the signals SIG may be signals defined by at least one of various interfaces such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer small interface (SCSI), enhanced small disk interface (ESDI), integrated drive electronics (IDE), Firewire, universal flash storage (UFS), Wi-Fi, Bluetooth, and nonvolatile memory express (NVMe) interfaces, etc.

The auxiliary power supply 3230 may be coupled to the host 3100 through the power connector 3002. The auxiliary power supply 3230 may be supplied with power PWR from the host 3100 and may be charged. The auxiliary power supply 3230 may supply the power of the SSD 3200 when the supply of power from the host 3100 is not smoothly performed. In an embodiment, the auxiliary power supply 3230 may be positioned inside the SSD 3200 or positioned outside the SSD 3200. For example, the auxiliary power supply 3230 may be disposed in a main board and may supply auxiliary power to the SSD 3200.

The buffer memory 3240 functions as a buffer memory of the SSD 3200. For example, the buffer memory 3240 may temporarily store data received from the host 3100 or data received from the plurality of flash memories 3221 to 322n or may temporarily store metadata (e.g., mapping tables) of the flash memories 3221 to 322n. The buffer memory 3240 may include volatile memories such as DRAM, SDRAM, DDR SDRAM, LPDDR SDRAM, and GRAM or nonvolatile memories such as FRAM, ReRAM, STT-MRAM, and PRAM, etc.

FIG. 16 is a block diagram illustrating a user system 4000 to which the storage device in accordance with an embodiment of the present disclosure is applied.

Referring to FIG. 16, the user system 4000 may include an application processor 4100, a memory module 4200, a network module 4300, a storage module 4400, and a user interface 4500.

The application processor 4100 may run components included in the user system 4000, an operating system (OS) or a user program. In an embodiment, the application processor 4100 may include controllers, interfaces, graphic engines, etc. for controlling the components included in the user system 4000. The application processor 4100 may be provided as a system-on-chip (SoC).

The memory module 4200 may function as a main memory, a working memory, a buffer memory or a cache memory of the user system 4000. The memory module 4200 may include volatile RAMs such as DRAM, SDRAM, DDR SDRAM, DDR2 SDRAM, DDR3 SDRAM, LPDDR SDARM, and LPDDR3 SDRAM, or nonvolatile RAMs such as PRAM, ReRAM, MRAM, and FRAM, etc. In an embodiment, the application processor 4100 and the memory module 4200 may be packaged based on package-on-package (POP) and may then be provided as a single semiconductor package.

The network module 4300 may communicate with external devices. For example, the network module 4300 may support wireless communication, such as code division multiple access (CDMA), global system for mobile communication (GSM), wideband CDMA (WCDMA), CDMA-2000, time division multiple access (TDMA), long term evolution (LTE), WiMAX, WLAN, UWB, Bluetooth, or Wi-Fi communication, etc. In an embodiment, the network module 4300 may be included in the application processor 4100.

The storage module 4400 may store data therein. For example, the storage module 4400 may store data received from the application processor 4100. Alternatively, the storage module 4400 may transmit the data stored in the storage module 4400 to the application processor 4100. In an embodiment, the storage module 4400 may be implemented as a nonvolatile semiconductor memory device, such as a phase-change RAM (PRAM), a magnetic RAM (MRAM), a resistive RAM (RRAM), a NAND flash memory, a NOR flash memory, or a NAND flash memory having a three-dimensional (3D) structure, etc. In an embodiment, the storage module 4400 may be provided as a removable storage medium (i.e., removable drive), such as a memory card or an external drive of the user system 400.

In an embodiment, the storage module 4400 may include a plurality of nonvolatile memory devices, and each of the plurality of nonvolatile memory devices may be operated in the same manner as that of the memory device 100, described above with reference to FIGS. 2 and 5. The storage module 4400 may be operated in the same manner as that of the storage device 50, described above with reference to FIG. 1.

The user interface 4500 may include interfaces which input data or instructions to the application processor 4100 or output data to an external device. In an embodiment, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric device, etc. The user interface 4500 may further include user output interfaces such as an a liquid crystal display (LCD), an organic light emitting diode (OLED) display device, an active matrix OLED (AMOLED) display device, an LED, a speaker, and a motor, etc.

Various embodiments of the present disclosure may provide a storage device capable of throttling the performance depending on the temperature, and a method of operating the storage device.

While the examples of embodiments of the present disclosure have been disclosed for illustrative purposes, those skilled in the art will appreciate that various modifications, additions and substitutions are possible. Therefore, the scope of the present disclosure must be defined by the appended claims and equivalents of the claims rather than by the description preceding them.

In the above-discussed embodiments, all steps may be selectively performed or skipped. In addition, the steps in each embodiment may be not always performed in regular order. Furthermore, the embodiments disclosed in the present specification and the drawings aims to help those with ordinary knowledge in this art more clearly understand the present disclosure rather than aiming to limit the bounds of the present disclosure. In other words, one of ordinary skill in the art to which the present disclosure belongs will be able to easily understand that various modifications are possible based on the technical scope of the present disclosure.

Embodiments of the present disclosure have been described with reference to the accompanying drawings, and specific terms or words used in the description should be construed in accordance with the spirit of the present disclosure without limiting the subject matter thereof. It should be understood that many variations and modifications of the basic inventive concept described herein will still fall within the spirit and scope of the present disclosure as defined in the appended claims and their equivalents.

What is claimed is:

1. A storage device comprising:
a plurality of memory devices divided into a plurality of performance throttle groups; and
a memory controller configured to obtain temperature information from indicator chips included in the plurality of respective performance throttle groups, and control operations of memory devices included in a performance throttle group selected from among the plurality of performance throttle groups based on the temperature information.

2. The storage device according to claim 1, wherein each of the indicator chips is any one of at least two or more memory devices included in a corresponding one of the plurality of performance throttle groups.

3. The storage device according to claim 1, wherein the memory controller comprises a performance adjustment unit configured to compare the temperature information with a threshold temperature, detect a performance limit group which is a performance throttle group including an indicator chip having a temperature exceeding the threshold temperature, and perform a performance throttling operation on memory devices included in the performance limit group.

4. The storage device according to claim 3, wherein the performance adjustment unit comprises:
a temperature information input unit configured to receive the temperature information from the indicator chips and detect the performance limit group; and
a performance adjustment control unit configured to limit power to be applied to the memory devices included in the performance limit group.

5. The storage device according to claim 1, wherein the temperature information comprises information about temperatures measured by temperature sensors included in the respective indicator chips.

6. The storage device according to claim 1, wherein each of the indicator chips is determined based on physical locations of a plurality of memory devices included in a corresponding one of the plurality of performance throttle groups.

7. A storage device comprising:
a plurality of memory devices; and
a memory controller configured to receive temperature information from the plurality of memory devices, and perform a performance throttling operation on at least one memory device having a temperature exceeding a threshold temperature among the plurality of memory devices, based on the temperature information.

8. The storage device according to claim 7, wherein the performance throttling operation comprises an operation of limiting power to be applied to the at least one memory device having the temperature exceeding the threshold temperature.

9. The storage device according to claim 7, wherein the memory controller comprises a performance adjustment unit configured to compare the temperature information with the threshold temperature, and perform a performance throttling operation on the memory device having the temperature exceeding the threshold temperature.

10. The storage device according to claim 9, wherein the performance adjustment unit comprises:
a temperature information input unit configured to receive the temperature information from the plurality of memory devices, and detect a performance limit device which is the memory device having the temperature exceeding the threshold temperature; and
a performance adjustment control unit configured to limit power to be applied to the performance limit device.

11. The storage device according to claim 7, wherein the temperature information comprises information about temperatures measured from temperature sensors included in the plurality of respective memory devices.

12. A method of operating a storage device including a plurality of memory devices divided into a plurality of performance throttle groups, and a memory controller configured to control the plurality of memory devices, the method comprising:
obtaining temperature information from indicator chips included in the plurality of respective performance throttle groups; and
controlling operations of memory devices included in a performance throttle group selected from among the plurality of performance throttle groups based on the temperature information.

13. The method according to claim 12, wherein the controlling the operation of the memory devices comprises:
comparing the temperature information with a threshold temperature, and detecting a performance limit group which is a performance throttle group including an indicator chip having a temperature exceeding the threshold temperature; and
performing a performance throttling operation on memory devices included in the performance limit group.

14. The method according to claim 13, wherein the performance throttling operation comprises an operation of limiting power to be applied to the memory devices included in the performance limit group.

15. The method according to claim 12, wherein the temperature information comprises information about temperatures measured by temperature sensors included in the respective indicator chips.

16. The method according to claim 12, wherein each of the indicator chips is determined based on physical locations of a plurality of memory devices included in a corresponding one of the plurality of performance throttle groups.

17. The method according to claim 12, wherein each of the indicator chips is any one of at least two or more memory devices included in a corresponding one of the plurality of performance throttle groups.

18. A memory device comprising:
a memory cell array;
a temperature sensor configured to measure a temperature related to the memory cell array, and generate a temperature signal having a voltage level varying depending on the measured temperature; and
a control logic configured to provide temperature information generated based on the temperature signal, to a memory controller external to the memory device in response to a request of the memory controller.

19. The memory device according to claim 18, wherein the memory device is an indicator chip which is a memory device a temperature of which represents temperatures of a plurality of memory devices to be managed along with the memory device.

20. The memory device according to claim 19, wherein the indicator chip is determined based on physical locations between the memory device and the plurality of memory devices.
